(19) United States
(12) Patent Application Publication
(10) Pub. No.: US 2008/0263626 A1
(43) Pub. Date: Oct. 23, 2008

(54) Method and system for logging a network communication event

(75) Inventors: Matthew Bainter, Chillicothe, IL (US); Amanda N. Pettit, Washinton, IL (US); James O. Hutson, Chillicothe, IL (US); Paul D. Force, Morton, IL (US); Randy J. Rush, Pekin, IL (US); Anthony A. Crumb, Canton, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 12/080,716

(22) Filed: Apr. 4, 2008

Related U.S. Application Data
(60) Provisional application No. 60/923,899, filed on Apr. 17, 2007.

(51) Int. Cl. G06F 17/00

(52) U.S. Cl. 726/1; 707/100; 707/E17.001

(57) ABSTRACT

A method of logging a network communication event includes a step of identifying a network communication event within a communication leaving a computer network. The method also includes steps of identifying a network address associated with the communication, and associating a user identity with the network address. It should be appreciated that the network address may include a dynamic network address. In addition, information is logged associating the user identity with the network communication event.

### CROSS-REFERENCE TO RELATED PATENT APPLICATIONS

This application claims priority to provisional U.S. Patent Application Ser. No. 60/923,899, filed Apr. 17, 2007, entitled “METHOD AND SYSTEM FOR LOGGING A NETWORK COMMUNICATION EVENT.”

### TECHNICAL FIELD

The present disclosure relates generally to logging a network communication event, and more particularly to identifying a user identity associated with the network communication event based on a network address.

### BACKGROUND

Monitoring software is well known for gathering information about a network and/or improving the security of a network. For example, monitoring software may be used to monitor network communications to ensure user compliance with a network security policy and/or to ensure that confidential data is not transmitted outside the network. According to a specific example, the monitoring software may be configured to scan all outgoing and/or incoming network communications, such as, for example, email (messages and/or attached documents), instant messages, web postings, file transfers, voice over internet, and others to identify a network communication event. A network communication event may be defined based on user preferences and may, for example, include a violation of a security policy, an event relating to email use, Internet use, document management, and/or software use or compliance.

The monitoring software may also be configured to perform or initiate a relevant action in response to the identified network communication event. For example, it may be desirable to record such an event in a log file, prevent transfer of the communication, extract specific content of the communication that triggered the event, encrypt the communication, notify a network administrator, notify the owner of the communication, and/or perform any other relevant action. U.S. Patent Application Publication No. 2005/0027723 teaches a similar system for identifying and reporting policy violations within network messages, such as email messages. Specifically, the content of a network message is compared to one or more policies, as defined within a database or other similar structure, to identify a policy violation. Information pertaining to the policy violation, including a user or source associated with the message containing the violation, may be displayed on a user interface or may be transmitted to a predefined user. Typically, however, monitoring software is configured to identify and record the network address of the communication containing the network communication event. However, since network addresses may be dynamic, as is well known in the art, it has been difficult to link the network address with the user or source of the communication.

The present disclosure is directed to one or more of the problems set forth above.

### SUMMARY OF THE DISCLOSURE

In one aspect, a method of logging a network communication event includes a step of identifying a network communication event within a communication leaving a computer network. The method also includes steps of identifying a network address associated with the communication, and associating a user identity with the network address. In addition, information is logged associating the user identity with the network communication event.

In another aspect, a system for logging a network communication event includes a computer network configured to communicate with an external source via a monitored pathway. A monitoring tool is positioned along the monitored pathway for monitoring a communication from the network and identifying a network communication event within the communication. A linking feature associates a user identity from a user identity database with a network address of the communication. A repository is also provided for storing information associating the user identity with the network communication event.

### BRIEF DESCRIPTION OF THE DRAWINGS

FIG. 1 is a block diagram of a system according to the present disclosure;

FIG. 2 is a flow chart of one embodiment of a method of logging a network communication event according to the present disclosure; and

FIG. 3 is a diagram of exemplary embodiments for implementing the method of FIG. 3.

### DETAILED DESCRIPTION

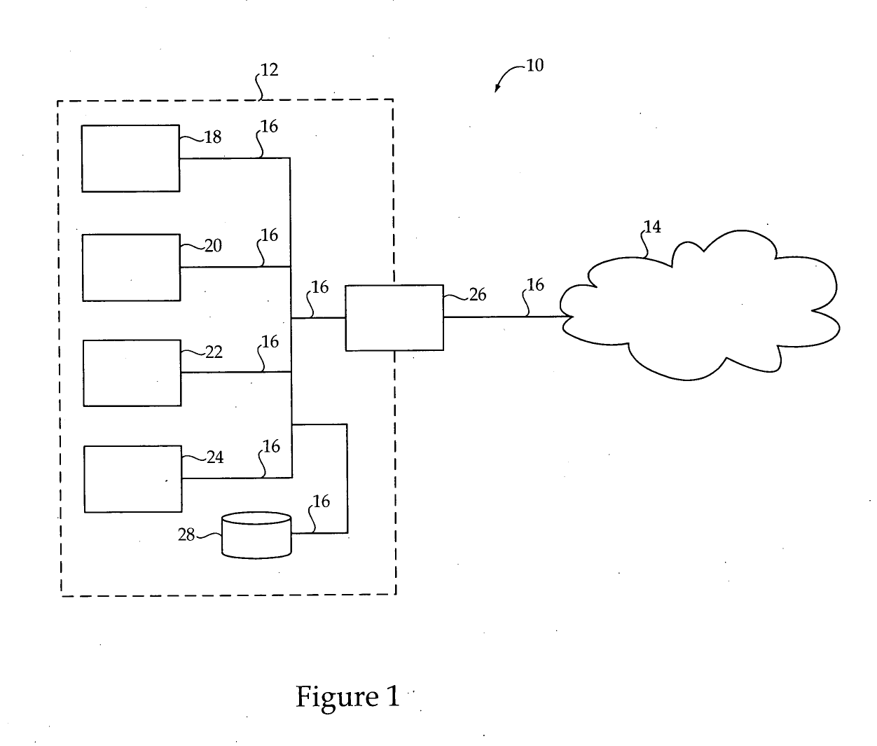

An exemplary embodiment of a system 10 for logging a network communication event is shown generally in FIG. 1. The system 10 may be a network including one or more sources in communication with one or more additional sources. For example, the system 10 may include a network 12, such as a private or protected network, in communication with an external source or outside network 14, such as, for example, the Internet, via a monitored pathway. The monitored pathway may include one or more communication conduits 16, which may be or include one or more wireless segments. The private network 12 and outside network 14 may each be of any variety of networks, such as corporate intranets, home networking environments, local area networks, and wide area networks, among others, and may include wired and/or wireless connections. Further, any of the known protocols, such as, for example, TCP/IP, NetBEUI, or HTTP, may be implemented to facilitate network communication.

Computers having processors and memories may be distributed throughout the private network 12, as is well known in the art. Also connected to the private network 12 may be printers, scanners, facsimile machines, servers, databases, and the like. Although specific examples are given, it should be appreciated that the private network 12 may include any addressable device, system, router, gateway, subnetwork, or other similar device or structure.

Each of the workstations 18, 20, 22, and 24, and any other participating network devices, may be assigned a dynamic network address that it uses to identify and communicate with various other network devices and the outside network 14. An exemplary network address may include an Internet protocol (IP) address for networks utilizing the IP communications protocol. Typically, a workstation 18, 20, 22, or 24 broadcasts a request to a service provider of the private network 12 for a network address. A unique network address may, in turn, be assigned, and the workstation 18, 20, 22, or 24 configures itself to use that network address. If, however, the workstation 18, 20, 22, or 24 is not continuously connected to the private network 12, the network address or, more specifically, the “dynamic” network address, it was using will be surrendered and may be reused by other workstations. Therefore, during the course of a day, several of the workstations 18, 20, 22, and 24 or other network devices may have utilized the same dynamic network address.

The private network 12 may also include a monitoring tool 26 for monitoring communications within the network 12. For example, the monitoring tool 26 may be disposed to monitor communications between the private network 12 and the outside network 14. Similarly, the monitoring tool 26 may be disposed to monitor communications within the private network 12, such as communications transmitted via any one or more of the plurality of communication conduits 16. The monitoring tool 26 may include monitoring hardware and/or software that may be executed on a server, workstation, or other machine or device. The monitoring tool 26 may scan all outgoing and/or incoming communications, such as, for example, email (messages and/or attached documents), instant messages, web postings, file transfers, voice over internet, and others, to detect a network communication event, such as, for example, a violation of a security policy. Other network communication events may include, but are not limited to, events or violations relating to email use, Internet use, document management, and software use or compliance.

According to one embodiment, it may be desirable for the private network 12 to electronically monitor network user compliance with a network security policy stored in a database 28. Specifically, it may be desirable to make sure all outgoing communications comply with the security policy of the private network 12 and that confidential data is not lost. Such communications monitoring software or, more specifically, data loss prevention software may be provided by Vontu® of San Francisco, Calif. Although a specific example is given, however, it should be appreciated that any variety of monitoring software is contemplated, including any other commercially available software.

Rules governing use and security within the private network 12 may be articulated and stored in the database 28. The monitoring tool 26 may apply and compare the rules articulated in the database 28 to communications leaving the private network 12 to make a decision whether an activity, a pattern of activity, or a specific communication content reflects a network communication event. Each network communication event may be categorized, ranging from a mild event to a severe event, and may trigger an automated action based on the category of the event or the number of events that have been detected. Exemplary actions may include recording the information in a log file, preventing transfer of the communication, extracting content of the communication that triggered the event, encrypting the communication, notifying an administrator of the private network 12, notifying the owner of the communication, or any other action deemed desirable.

Database 28 may also be a user identity database or repository configured to store a user identity profile for each user or employee having access to the private network 12. The user identity profile may include information relating to a user identity, such as, for example, a full name of an individual, home address, phone number, email address, contact information, and various other information. This user identity data may be useful in identifying, locating, or contacting the user transmitting a communication that contains a network communication event. However, typical monitoring tools, such as monitoring tool 26, are configured to identify and record the network address of the communication containing a network communication event, rather than the user identity data. Since network addresses may be dynamic, as described above, it may be desirable to provide a link between the network address associated with the network communication event and specific user identity information for the user provisioned the dynamic network address at the time the network communication event was detected.

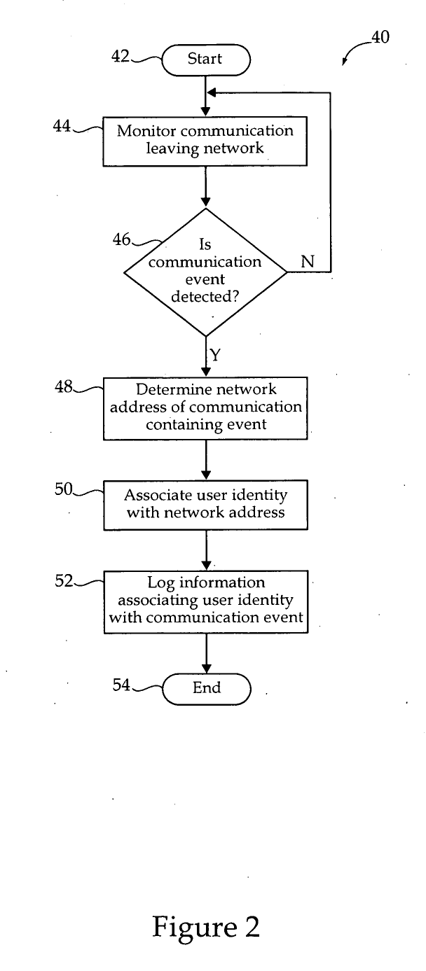

Turning to FIG. 2, there is shown a flow chart 40 representing an exemplary method of logging a network communication event. Specifically, the network address, such as a dynamic network address, associated with the network communication event is used to ascertain the identity of the user of the network address at the time the communication triggering the event occurred. The method may be implemented in whole, or in part, by the monitoring tool 26 described above. For example, the steps implementing the disclosed method may be stored in memory and executed by a processor of the monitoring tool 26. Alternatively, the method may be implemented using a network based application that can be stored on any machine or server and may be called up and manipulated from any location. In a further embodiment, the method may be implemented through a software agent stored on predetermined machines, servers, and workstations, such as workstation 18, 20, 22, or 24, connected to the private network 12.

The method begins at a START, Box 42. From Box 42, the method proceeds to Box 44, which includes the step of monitoring communications leaving the private network 12. The communications may be monitored to detect a network communication event, as described above. From Box 44, the method proceeds to Box 46. At Box 46, the monitoring tool 26 determines if, in fact, a network communication event is detected within the communications leaving the private network 12. If a network communication event is detected, the method proceeds to Box 48. If, however, a network communication event is not detected, the method returns to Box 44, where outgoing communications are continuously monitored.

At Box 48, the monitoring tool 26 reads the network address, such as a dynamic network address, of the communication containing the event. From Box 48, the method proceeds to Box 50, where a user identity is associated with the network address via a linking feature. The linking feature, as should be appreciated, may or may not be included with the monitoring tool 26. Specifically, the network address may be used by a system management application, or similar utility, tool, or feature, to instantaneously, or near instantaneously, access user identity information associated with the network address. According to one embodiment, such user identity information may be stored in, and accessed from, the user identity database 28 or other similar data repository.

After the user identity information is retrieved, the method proceeds to Box 52. At Box 52, information may be logged that associates the user identity with the network communication event. This information may be logged in database 28, or any other storage device, and may be accessed by one or more users of the private network 12, as deemed necessary. In addition, any of the automated actions described above may be triggered, such as, for example, preventing transfer of the communication, extracting content of the communication that triggered the event, encrypting the communication, notifying an administrator of the private network 12, or notifying the owner of the communication.

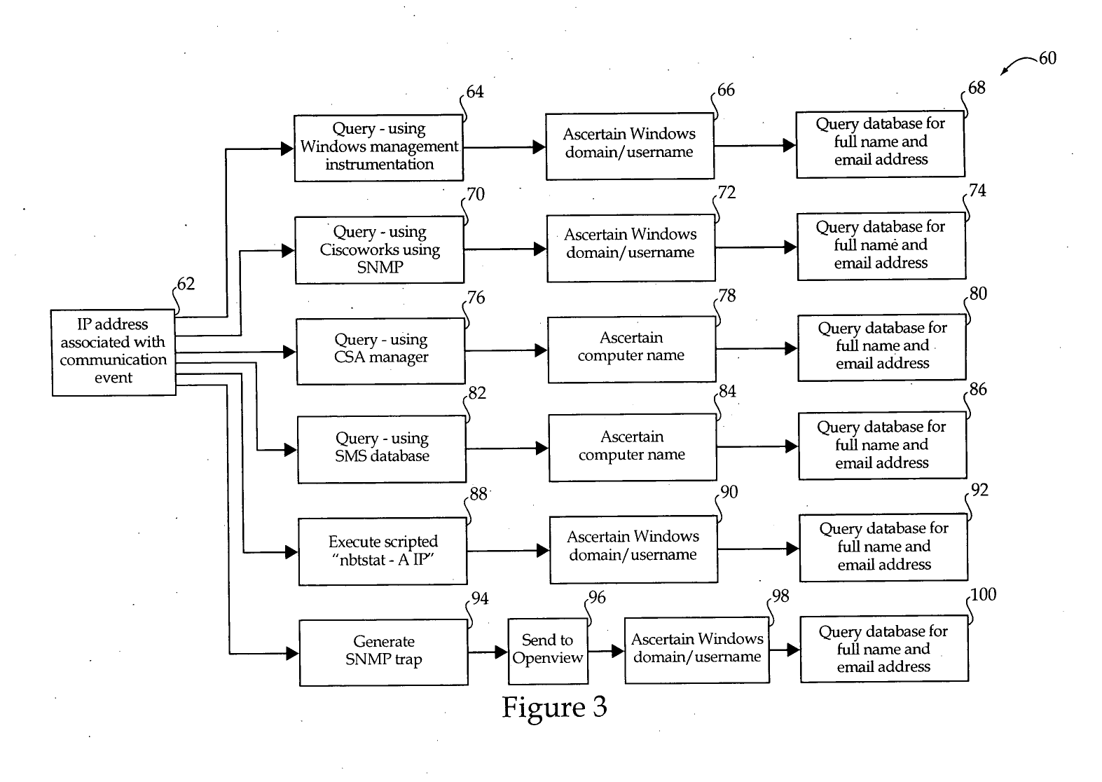

Specific examples 60 of implementing the method of FIG. 2 or, more specifically, the method step designated at Box 50, can be seen in FIG. 3. Turning specifically to Box 62 of FIG. 3, a network address or, for example, an IP address, associated with a network communication event may be ascertained by the monitoring tool 26. According to a first example, at Box 64, Microsoft® Windows Management Instrumentation (WMI), a set of extensions to the Windows Driver Model that provides an operating system interface through which various components can provide system information, uses the IP address to query the system 10. At Box 66, the Windows domain and username associated with the IP address are returned. The domain and username are then used at Box 68 to query a user identity database, such as database 28, to ascertain a full name for an individual and an email address associated with the domain and username, and any other information deemed pertinent.

A second example, shown at Box 70, includes the use of CiscoWorks, a network management product from Cisco® that uses the Simple Network Management Protocol (SNMP) to monitor and control devices on a network. The IP address may be used by CiscoWorks to query the system 10. At Box 72, the Windows domain and username associated with the IP address are returned. The domain and username are then used at Box 74 to query the database 28 to ascertain a full name for an individual and an email address associated with the domain and username.

A third example, shown at Box 76, utilizes Cisco Security Agent (CSA) Manager, a component of the CSA network intrusion prevention software provided by Cisco®, to similarly query the system 10 using the IP address. At Box 78, the computer name is returned and used to query the database 28, at Box 80. It should be appreciated that an additional database that links a computer name with a domain and username may also be utilized to ascertain a full name of an individual and an email address associated with the computer name.

According to a fourth example, shown at Box 82, Systems Management Server (SMS), a set of tools from Microsoft® that assists in managing devices or workstations connected to a network, uses the IP address to query the system 10. At Box 84, the computer name associated with the IP address is returned. This computer name is then used to query the database 28, at Box 86, or an alternative database, such as an SMS database. An SMS database may be connected to the database 28 and may link a computer name with a domain name and username to ascertain a full name of an individual and an email address associated with the computer name.

A fifth example, shown at Box 88, includes the use of a Microsoft—Disk Operating System (MS-DOS) utility that displays current TCP/IP connections. Specifically, the nbtstat.exe process may be used to provide the Windows domain and username when given an IP address, shown at Box 90. The domain and username are then used, at Box 92, to query the database 28 to ascertain a full name for an individual and an email address associated with the domain and username.

According to a sixth example, shown at Box 94, an SNMP trap, which enables an agent to provide a notification when a significant event occurs, may be utilized. The SNMP trap, in conjunction with an additional network management tool, such as, for example, the OpenView product of Hewlett Packard®, may be used to ascertain the Windows domain and username associated with the IP address, shown at Box 98. The domain and username may then be used, at Box 100, to query the database 28 to ascertain a full name for an individual and an email address associated with the domain and username.

Although specific examples are given, it should be appreciated by those skilled in the art that any application, utility, or tool may be used to ascertain a computer name and/or domain name and username associated with a workstation or machine based on a network address, such as, for example, a dynamic network address. This information can then be used, in real-time, to gather more user specific information related to the computer name or username to ultimately associate a specific user identity to a communication triggering a network communication event.

### INDUSTRIAL APPLICABILITY

Referring to FIGS. 1-3, an exemplary embodiment of a system 10 for logging a network communication event may include a private network 12 in communication with an external source, such as network 14, via one or more communication conduits 16. It should be appreciated, however, that the system 10 may include any number and/or configuration of devices in communication with one or more other devices and should not be limited to the specific embodiment shown. Workstations 18, 20, 22, and 24 and various other devices may be distributed throughout the private network 12, as should be appreciated by those skilled in the art.

A monitoring tool 26 may also be provided for monitoring any one or more of the plurality of communication conduits 16 between the private network 12 and the external network 14. As such, the communication conduits 16 may also be referred to as a monitored pathway. Specifically, the monitoring tool 26 may monitor communications leaving the private network 12. According to one embodiment, the monitoring tool 26 may scan all outgoing communications, such as, for example, email (messages and/or attached documents), instant messages, web postings, file transfers, voice over internet, and others, to detect a network communication event, such as, for example, a violation of a security policy.

It may be desirable, according to one embodiment, to determine whether a monitored communication, such as an email, contains pre-selected data, as defined in a database 28. The pre-selected data may, for example, include confidential data that is prohibited from being sent outside the private network 12. As such, this confidential data may represent and/or trigger a network communication event. If such a network communication event is detected, the method of FIG. 2 may be utilized to gather user identity information for the user provisioned the network address associated with the communication containing the pre-selected data. Specifically, the monitoring tool 26 may read the network address, such as a dynamic network address, of the communication containing the pre-selected data (Box 48), and associate the network address with a user identity using a linking feature (Box 50). For example, the network address may be used by one or more of the applications described with reference to FIG. 3 to instantaneously, or near instantaneously, access user identity information, such as from a database 28, associated with the network address. Thereafter, the user identity information may be logged that associates the communication owner with the network communication event (Box 52).

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A method of logging a network communication event, comprising:
identifying a network communication event within a communication, wherein the communication is leaving a computer network;
identifying a network address associated with the communication;
associating a user identity with the network address; and
logging information associating the user identity with the network communication event.

2. The method of claim 1, further including continuously monitoring communications leaving the computer network using a monitoring tool.

3. The method of claim 2, wherein the continuously monitoring step includes continuously monitoring communications leaving a private network.

4. The method of claim 1, wherein the step of identifying the network communication event includes comparing the communication to rules defined within a database.

5. The method of claim 4, wherein the step of identifying the network communication event includes detecting a violation of a security policy.

6. The method of claim 4, wherein the step of identifying the network communication event includes detecting at least one of an email use violation, an Internet use violation, a document management violation, and a software use violation.

7. The method of claim 1, wherein the step of identifying the network address includes identifying a dynamic network address associated with the communication.

8. The method of claim 7, wherein the associating step includes:
acquiring a unique user name associated with the dynamic network address; and
acquiring the user identity from a user identity database based on the unique user name.

9. The method of claim 8, wherein the step of acquiring the user identity includes acquiring at least one of a full name of an individual and an email address from the user identity database.

10. A system for logging a network communication event, comprising:
a computer network configured to communicate with an external source via a monitored pathway;
a monitoring tool positioned along the monitored pathway for monitoring a communication from the network and identifying a network communication event within the communication;
a user identity database;
a linking feature for associating a user identity from the user identity database with a network address of the communication; and
a repository for storing information associating the user identity with the network communication event.

11. The system of claim 10, wherein the monitoring tool is configured to continuously monitor communications leaving the computer network.

12. The system of claim 11, wherein the computer network is a private computer network.

13. The system of claim 10, wherein the monitoring tool is configured to compare the communication to rules defined within a database.

14. The system of claim 13, wherein the monitoring tool is further configured to detect a violation of a security policy.

15. The system of claim 13, wherein the monitoring tool is further configured to detect at least one of an email use violation, an Internet use violation, a document management violation, and a software use violation.

16. The system of claim 10, wherein the monitoring tool includes the linking feature.

17. The system of claim 16, wherein the monitoring tool is configured to identify the network address of the communication containing the network communication event.

18. The system of claim 17, wherein the network address includes a dynamic network address.

19. The system of claim 18, wherein the linking feature is configured to acquire a unique user name associated with the dynamic network address, and acquire the user identity from a user identity database based on the unique user name.

20. The system of claim 19, wherein the user identity includes at least one of a full name of an individual and an email address.
